(19) United States
(12) Patent Application Publication
(10) Pub. No.: US 2017/0130496 A1
(43) Pub. Date: May 11, 2017

(54) LOCK BODY HAVING FOUR-SIDED LOCKING STRUCTURE

(71) Applicant: Jiangsu Zhongheng Pet Articles Joint-Stock Co., Ltd., Jiangsu (CN)

(72) Inventor: Qiu Bin, Jiangsu (CN)

(73) Assignee: Jiangsu Zhongheng Pet Articles Joint-Stock Co., Ltd., Jiangsu (CN)

(21) Appl. No.: 15/348,957

(22) Filed: Nov. 10, 2016

(30) Foreign Application Priority Data
Nov. 10, 2015 (CN) 201520892866.8

(51) Int. Cl. E05C 9/20; E05C 9/00

(52) U.S. Cl. CPC E05C 9/20; E05C 9/00

(57) ABSTRACT

A lock body having a four-sided locking structure includes a positioning cover body, a connecting cover body, a locking cover body and a knob, wherein the positioning cover body and the locking cover body form a chamber, and an upper locking structure, a lower locking structure, a left locking structure and a right locking structure are disposed on the chamber. The connecting cover body is positioned in the chamber, and the connecting cover body is connected with the knob positioned outside the chamber. The lock body disclosed by the present invention realizes locking by means of the four locking structures, namely the upper locking structure, the lower locking structure, the left locking structure and the right locking structure disposed on the lock body, and overcomes the problem that the traditional lock body structure is easy to slip owing to insufficient locking force.

### CROSS-REFERENCE TO RELATED APPLICATIONS

This application claims the priority of Chinese Patent Application No. 201520892866.8, filed on Nov. 10, 2015, the disclosure of which is incorporated by reference in its entirety.

### TECHNICAL FIELD

The present invention relates to the field of lock bodies, in particular to a lock body having a four-sided locking structure.

### BACKGROUND ART

The existing lock body structure is only equipped with an upper locking structure and a lower locking structure, and such structure has the following drawbacks: the two locking structures can only form a linear locking mode, resulting in the problem of ease of slip owing to insufficient locking force.

### SUMMARY OF THE INVENTION

The present invention is directed to the defects of the prior art, and an objective thereof is to provide a locking having a four-sided locking structure to solve said problem.

The technical problem to be solved by embodiments of the present invention may be realized by adopting the following technical solutions:

a lock body having a four-sided locking structure, comprising a lock body portion equipped with an upper locking structure and a lower locking structure, and the lock body portion is also equipped with a left locking structure and a right locking structure.

Further, the lock body portion comprises a positioning cover body and a locking cover body; and the positioning cover body and the connecting cover body are matched to form a chamber, and the upper locking structure, the lower locking structure, the left locking structure and the right locking structure are respectively disposed on the chamber.

Further, the lock body portion also comprises a connecting cover body and a knob; and the connecting cover body is positioned in the chamber and is connected with the knob positioned outside the chamber.

Further, the positioning cover body comprises a first circular cover body, wherein the edge position of the first circular cover body extends towards the inner side to form a ring edge structure, the ring edge structure is provided with a plurality of first grooves for location with grid bars of a grid mesh, and a first hollow cavity structure is formed on the inner side of the ring edge structure, an axial hole is formed in the middle position of the first hollow cavity structure, and a connecting portion provided with a connecting hole is disposed on the outer side of the ring edge structure.

Further, the connecting cover body comprises a second circular cover body, wherein the edge position of the second circular cover body extends towards the inner side to form a ring edge structure, and the ring edge structure is also provided with a plurality of second grooves for location with grid bars of a grid mesh; each first groove and each second groove are semicircular grooves respectively and are attached to form a through hole; a second hollow cavity structure is formed on the inner side of the ring edge structure, a transmission hole and a positioning shaft are disposed in the second hollow cavity structure, the second hollow cavity structure and the first hollow cavity structure form a chamber, and a connecting end is also disposed on the outer side of the ring edge structure.

Further, the locking cover body is mounted in the chamber formed by the positioning cover body and the connecting cover body; and the locking cover body comprises a cover plate, a connecting shaft is disposed in the middle of one side of the cover plate, the end portion of the connecting shaft is positioned the axial hole of the first chamber, and a transmission shaft and a positioning groove are disposed on the other side of the cover plate, the end portion of the transmission shaft penetrates through the transmission hole in the second hollow cavity structure, and the positioning groove is connected with a positioning shaft in the second hollow cavity structure.

The knob is positioned on the outer side of the connecting cover body and is provided with a connecting groove, and the end portion of the transmission shaft of the locking cover body is positioned in the connecting groove, and is fixedly connected with the knob.

Further, the positioning cover body, the connecting cover body, the locking cover body and the knob are of an integrated structure respectively.

Compared with the prior art, the present invention has the beneficial effects:

the lock body disclosed by the present invention is simple in structure, ingenious in design and capable of realizing locking by means of the four locking structures disposed on the chamber formed by the positioning cover body and the connecting cover body, thus realizing a face type locking mode and overcoming the problem that the traditional lock body structure is easy to slip owning to insufficient locking force.

### BRIEF DESCRIPTION OF THE DRAWINGS

FIG. 1 shows a schematic diagram of the left side of a lock body having the four-sided locking structure according to one embodiment of the present invention.

FIG. 2 shows a schematic diagram of the right side of a lock body having the four-sided locking structure according to one embodiment of the present invention.

The reference numerals in the drawings are as follows: the positioning cover body 1, the connecting cover body 2, the locking cover body 3, the knob 4, the first circular cover body 5, the first groove 6, the axial hole 7, the first circular cover body 8, the second groove 9, the transmission hole 10, the positioning shaft 11, the cover plate 12, the connecting shaft 13, the transmission shaft 14, the positioning groove 15 and the connecting groove 16 are illustrated according to signs in FIGs.

### DETAILED DESCRIPTION

In order to facilitate the understanding the technical means, the creative characteristics, and the purposes and the effects implemented by embodiments of the present invention, the present invention will be further illustrated as follows in conjunction with the specific embodiments.

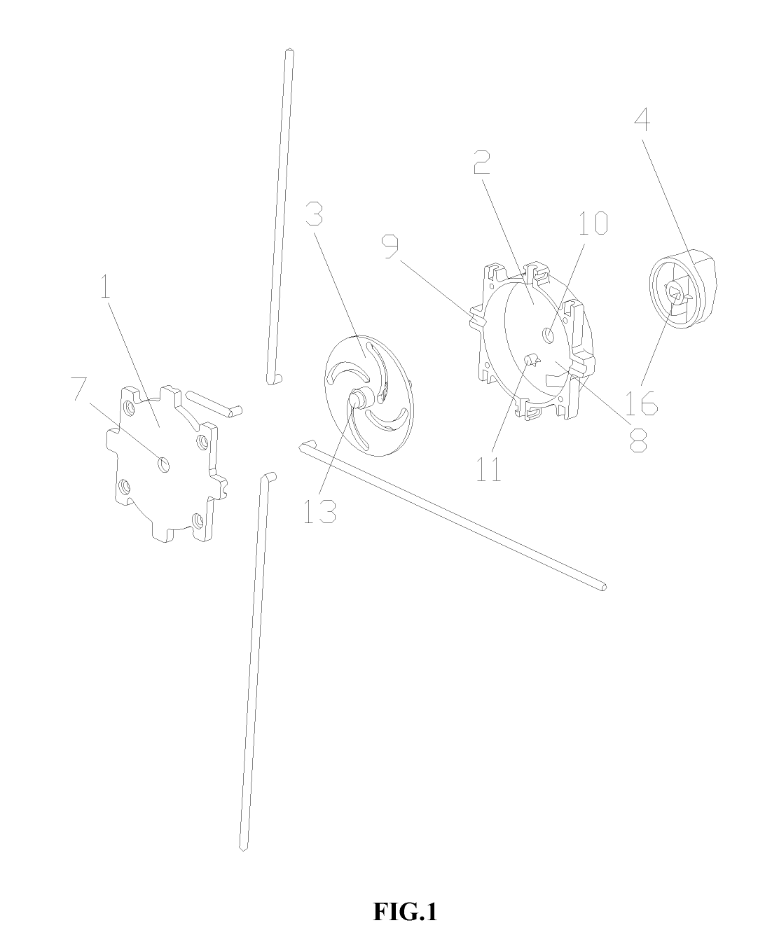

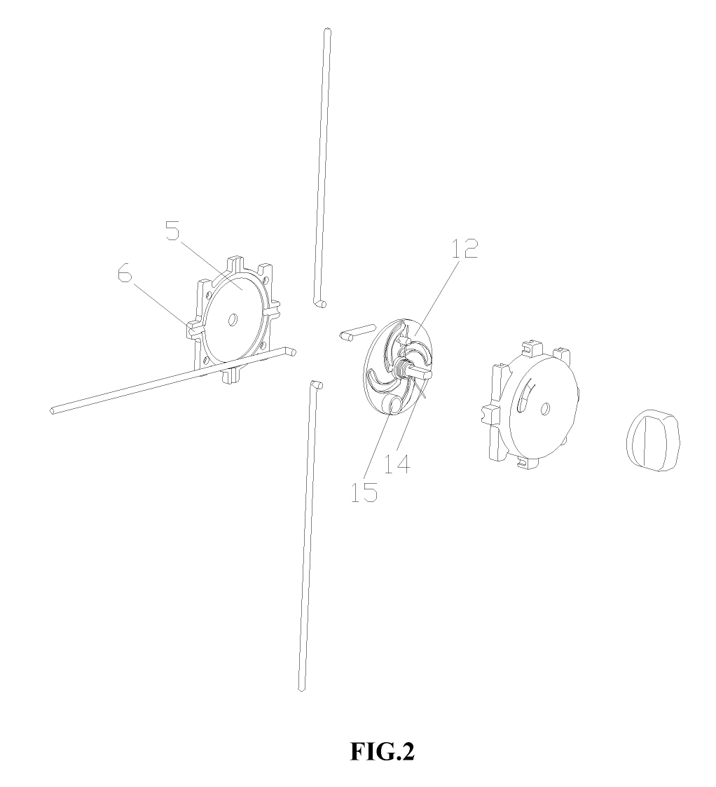

By Reference to FIG. 1 and FIG. 2, a lock body having a four-sided locking structure, which is disclosed by the present invention, comprises a positioning cover body 1, a connecting cover body 2, a locking cover body 3, and a knob 4.

The positioning cover body 1 comprises a first circular cover body 5, wherein the edge of the first circular cover body 5 extends towards the inner side to form a ring edge structure. The ring edge structure is provided with a plurality of first grooves 6 for positioning (accommodating) grid bars of a grid mesh. A first hallow cavity structure (a tub shaped cavity) is formed on the inner side of the ring edge structure. An axial hole 7 is formed at the center of the first hollow cavity structure. A connecting portion having connecting holes is disposed on the outer side (periphery) of the ring edge structure.

The connecting cover body 2 comprises a second circular cover body 8, wherein the edge of the second circular cover body 8 extends towards the inner side to form a second ring edge structure, and the ring edge structure have a plurality of second grooves 9 for positioning grid bars of a grid mesh. Each first groove 6 and each second groove 9 are semicircular grooves respectively and are attached to form a through hole. A second hollow cavity structure is formed on the inner side of the ring edge structure, a transmission hole 10 and a positioning shaft 11 are disposed in the second hollow cavity structure. The second hollow cavity structure and the first hollow cavity structure are attached to form a chamber. A connecting portion is also disposed on the outer side (periphery) of the second ring edge structure.

The locking cover body 3 is mounted in the chamber formed by the positioning cover body 1 and the connecting cover body 2. The locking cover body 3 comprises a cover plate 12. A connecting shaft 13 is disposed at the center of one side of the cover plate 12. The end portion of the connecting shaft 13 is positioned in the axial hole 7 of the first chamber. The other side of the cover plate 12 comprises a transmission shaft 14 and a positioning groove 15. An end portion of the transmission shaft 14 passes through the transmission hole 10 in the second hollow cavity structure. The positioning groove 15 is connected with the positioning shaft 11 in the second hollow cavity structure.

The knob 4 is positioned on the outer side of the connecting cover body 2 and is provided with a connecting groove (connecting trough) 16, and the end portion of the transmission shaft 14 of the locking cover body 3 is positioned in the connecting groove 16, and is fixedly connected with the knob 4.

In some embodiments of the invention, the positioning cover body 1, the connecting cover body 2, the locking cover body 3 and the knob 4 each may have an unitray construction.

The fundamental principles and the major characteristics of embodiments of the present invention and the advantages of the present invention are illustrated and described as above. Those skilled in the art should realize the present invention is not limited to aforesaid embodiments, and said embodiments and the description explain the principle of the present invention. One skilled in the art would appreciate that various modifications and improvements are possible without departing from the scope of the invention, and all of such modifications and improvements should fall within scope of the present invention. The protection scope of the present invention will be defined by attached claims and equivalents thereof.

What is claimed is:

1. A lock body having a four-sided locking structure, comprising a lock body portion equipped with an upper locking structure and a lower locking structure, wherein the lock body portion is equipped with a left locking structure and a right locking structure.

2. The lock body according to claim 1, wherein the lock body portion comprises a positioning cover body and a locking cover body; and the positioning cover body and the connecting cover body are matched to form a chamber, and the upper locking structure, the lower locking structure, the left locking structure and the right locking structure are respectively disposed on the chamber.

3. The lock body according to claim 2, wherein the lock body portion also comprises a connecting cover body and a knob; and the connecting cover body is positioned in the chamber and is connected with the knob positioned outside the chamber.

4. The lock body according to claim 2, wherein the positioning cover body comprises a first circular cover body, the edge position of the first circular cover body extends towards the inner side to form a ring edge structure, the ring edge structure is also provided with a plurality of first grooves for location with grid bars of a grid mesh, and a first hollow cavity structure is formed on the inner side of the ring edge structure, an axial hole is formed in the middle position of the first hollow cavity structure, and a connecting portion provided with a connecting hole is disposed on the outer side of the ring edge structure.

5. The lock body according to claim 2, wherein the connecting cover body comprises a second circular cover body, the edge position of the second circular cover body extends towards the inner side to form a ring edge structure, and the ring edge structure is also provided with a plurality of second grooves for location with grid bars of a grid mesh; each first groove and each second groove are semicircular grooves respectively and are attached to form a through hole; and a second hollow cavity structure is formed on the inner side of the ring edge structure, a transmission hole and a positioning shaft are disposed in the second hollow cavity structure, the second hollow cavity structure and the first hollow cavity structure are attached to form a chamber, and a connecting end is also disposed on the outer side of the ring edge structure.

6. The lock body according to claim 3, wherein the locking cover body is mounted in the chamber formed by the positioning cover body and the connecting cover body; the locking cover body comprises a cover plate, a connecting shaft is disposed in the middle of one side of the cover plate, the end portion of the connecting shaft is positioned the axial hole of the first chamber, and a transmission shaft and a positioning groove are disposed on the other side of the cover plate, the end portion of the transmission shaft penetrates through the transmission hole in the second hollow cavity structure, and the positioning groove is connected with a positioning shaft in the second hollow cavity structure, the knob is positioned on the outer side of the connecting cover body and is provided with a connecting groove, and the end portion of the transmission shaft of the locking cover body is positioned in the connecting groove, and is fixedly connected with the knob.

7. The lock body according to claim 3, wherein the positioning cover body, the connecting cover body, the locking cover body and the knob are of an integrated structure respectively.
